(19) United States
(12) Patent Application Publication
(10) Pub. No.: US 2004/0202499 A1
(43) Pub. Date: Oct. 14, 2004

(54) Fabrication of full page Braille display using the self supporting and hydraulic (SSH) system in the Braille cell based on the bending mechanism of electroactive polymer actuator

(76) Inventor: Peichun Yang, Chandler, AZ (US)

Correspondence Address: Peichun Yang, 1825 West Ray Road, #1054, Chandler, AZ, 85224, US

(21) Appl. No.: 10/763,359

(22) Filed: Jan. 26, 2004

Related U.S. Application Data
(60) Provisional application No. 60/448,143, filed on Feb. 20, 2003.

(51) Int. Cl. B41J 3/01

(52) U.S. Cl. 400/109; 434/114

(57) ABSTRACT

A novel hydraulic and latching (SSH) mechanism is invented to make the compact and low power consumption Braille cell based on the bending of the electroactive polymer actuators including PVDF polymer, IPMC and other electroactive polymers. The system comprises a rectangular cavity with four bending elements working at its two sides. The top of the cavity is sealed with a rubber membrane or a preformed membrane and the cavity is full of the water or other appropriate liquid to serve as the pressure transferring medium. The system transfers the bending of the electroactive polymer actuator into the linear motion of the Braille dot. A novel latching mechanism with two supporting blocks attaching to the bending elements and a thin rod attaching to the membrane is invented to provide over 30 grams supporting force which is the required for the Braille dot. The system provides the 0.7 mm displacement which is required for the travel of the Braille dot, large supporting force and quick response time (less than 0.1 second) simultaneously. The highly integrated microelectronic processing technology will be used to make an array of Braille cells. First, a row of the cavities are made and the bending elements are put at the two sides of the cavities. Then the top will be sealed with the membranes and the Cavities are full of the water or other appropriate liquid. By adding different number of rows of the Braille cells the multi line and full page Braille display can be fabricated using this technology.

### BACKGROUND OF INVENTION

The fabrication of the full page Braille display is highly demanded because it provides means for blind people to get access to both character and graphic information. The new Braille cell based on the electroactive polymer actuator technology will overcome the limitations of the piezo electric ceramic (PZT) Braille cell in terms of making the Braille display into a full page. Since the strain of the PZT is small the long lever type bimorph is used to make actuator to move the Braille dot. Therefore only one line of the Braille dots can be displayed. The advantage of using the electroactive polymer is that a large displacement can obtained. Meanwhile, the electroactive polymer is light weight. The power consumption is very low. Therefore light and compact full page Braille display can be fabricated using the modem micro electronic processing technology.

In order for blind people to have a comfortable feeling in reading the Braille character on a refreshable Braille display 30 grams supporting force for the Braille dot is needed. At the same time 0.7 mm displacement for the Braille dot and less than 100 ms response time are required.

In this patent a novel self supporting and hydraulic (SSH) system is employed to make a compact Braille cell that can provide over 30 grams supporting force, 0.7 mm displacement and less than 100 ms response time simultaneously.

### SUMMARY

It is noticed that the 30 grams supporting force is needed only when blind people actually brush their finger tip on the Braille dot. The force which is needed to push up the Braille dot itself is much less than 30 grams. Based on this observation a novel hydraulic and latching mechanism is employed to make a Braille cell that can provide 30 grams supporting force to give blind people a comfortable feeling when brushing their finger tip on the Braille dot. FIG. 1(a) (b) (c) shows the schematic of the steps to construct a SSH Braille cell and its working configurations. FIG. 1(a) shows the three dimensional schematic of the rectangular cavity and the working parts involved in SSH Braille cell. FIG. 1(b) shows the schematic of cross-section of the SSH Braille cell at its working configuration. As shown in this figure there are four bending elements fixed at two sides of the cavity. The height of the cavity is 5 mm. The width of the cavity is 1.25 mm which is the base diameter of a Braille dot. There is a round hole at the top of the cavity which is sealed with a rubber membrane. The diameter of the hole is 1.25 mm. The four bending elements are labeled A, B, C and D. The size of the four bending elements is equal. The dimension is 1.1 mm times 2 mm. There are two solid stripes at the middle of the two opposite sides of the cavity to construct four “windows”. The four bending elements are fixed at the stripes at two sides. The top of the bending elements A and B can bend towards inside and outside of the cavity. The bottom of the bending elements C and D can bend towards inside and outside of the cavity too. The four bending elements are attached to a rubber membrane or preformed membrane which is used to seal the cavity. Certain liquid such as water or other liquids will be used to fill up the housing to serve as the pressure transferring media. There is a thin rod attached to the bottom of the rubber membrane which is used to seal the hole at the top of the cavity. There is a relative large rectangular shape block attached to the bottom of the thin rod to stabilize the rod. The total length of the rod and block is 5 mm. The width of the stabilizing blocks is 0.65 mm. There are two blocks attached at the lower part of the bending elements C and D to serve as supporting elements. The height of the supporting blocks is 0.7 mm which is the displacement that is required for moving the Braille dot up to its latching position. The width of the two supporting blocks is 0.3 mm. Finally there is a Braille dot made of harder material sitting on top of the rubber membrane.

FIG. 2 shows the working sequence of the hydraulic and latching system in Braille cell based on the bending of the electroactive polymer. At the first step the four bending elements will bend towards inside the cavity when the power is on. As the bending elements bend towards inside the pressure will be exerted on the liquid which will push up the rubber membrane at the hole on the top of the cavity to make a 0.7 mm displacement. At the same time the two supporting blocks which are attached to the lower part of the bending elements C and D will move towards center of the cavity. Eventually the thin rod attached to the bottom of the rubber membrane will sit on the two supporting blocks. The height of the supporting blocks is 0.7 mm. Therefore very large supporting force can be generated while keeping the Braille dot at its 0.7 mm latching position since the thin rod is supported by the two blocks underneath it. The supporting force will be expected to be over 30 grams.

The bending angle of the electroactive polymer bending elements can be calculated by solving the equation in which the volumetric change caused by the removal of the volume of the liquid inside the cavity and the volumetric change caused by the inflation of the rubber membrane on the top of the cavity are equal . In doing so one can get the bending angle about 2.5 degrees.

Since the electroactive polymer has much larger strain comparing to the PZT the bending angle of the bimorph type bending elements made of the electroactive polymer can easily exceed 2.5 degrees.

At step two as shown in FIG. 1c when the power applied (such as voltage applied to the bimorph type bending elements or current applied to IPMC) is switched the four bending elements will bend towards outside of the housing. A negative pressure will be generated inside the housing. The combination of this negative pressure and the pressure from the rubber membrane will move the Braille dot to its rest position. The two supporting blocks will be moved away from the center of the housing. The bending elements C and D bend towards outside of the housing. Therefore the thin rod will drop back to its rest position.

There are many advantages for this design. First, the Braille cell is very compact. A multi line or full page Braille display that can demonstrate both character and graphic information can be fabricated. Secondly a novel hydraulic and latching mechanism is employed to provide over 30 gram supporting force for the Braille dot. Thirdly, the power consumption is very low since the large supporting force for the Braille dot is generated by the latching mechanism. The power consumed to drive the bending elements to generate the pressure to push up the rubber membrane and Braille dot is relative low. Finally, less than 100 ms response time can be achieved since the response time for the bending elements that are made of electroactive polymer is in a range of millisecond.

The bending elements can be made based on the bending mechanism of the electrostrictive polymer and ionic conducting (IPMC) polymer actuator. Similar to the finger structure the bending elements will be made into a sandwich structure which consists flexible electroactive polymer and hard material to serve as bone. The bending elements that have large bending angle and force output are expected to be made by smart design of the electroactive polymer actuator inspired by the natural muscle and bone structure.

FIG. 3 shows the schematic of the micro electrodes made on the PVDF polymer thin film. The thickness of the PVDf polymer thin film is in a range of 5 to 100 micrometer. The thin metal stripes are made on one side of the polymer thin film using photolithograph process. The positive and negative electrode stripes are in alternate sequence. The space between positive and negative electrodes is in a range of micrometer so that very high electric field can be exerted between the electrodes. In this way the working voltage for the device can be lowered dramatically. The working voltage for the current commercial Braille display is 200 V. The asymmetry stress caused by the asymmetry electric field can create the bending of the polymer thin film. Furthermore, the applied voltage can be lowered greatly since the space between the electrodes is very small.

In order to lower the cost for making the new Braille cell based on the electroactive polymer technology. The highly integrated microelectronic processing technology will be employed to make an array of the Braille dots at one time. For example for making a 4 lines by 40 cells Braille display a row of the housings with 80 cavities will first be made. Then the bending elements will be put at two sides of the housings. Then the membranes with thin rod attached to their back will be put at the top of the housings. So one row of the Braille cells can be made. By adding three rows of this array of the Braille dots one line Braille display can be made. We can add another three rows of the Braille cells to make two lines Braille display so on a 4 line by 40 cells Braille display can be made. If we add 75 rows of the Braille cells together a full page Braille display can be made.

The array of the bimorph type of the bending elements will be made using the integrated microelectronic processing technology. Since the electroactive polymer is flexable and can be made into thin films form the highly integrated microelectronic process can easily employed to make a row of the bending elements at one time. Therefore, the new Braille cell invented by this patent can be processed by the microelectronic processing technology. This is the key to the low cost and massive production of the new Braille cell.

In conclusion, a novel self supporting and hydraulic (SSH) system is invented in making the compact Braille cell which can provide over 30 grams supporting force, 0.7 mm displacement for the Braille dot and less than 100 ms response time simultaneously. Using this novel Braille cell a full page Braille display which will demonstrate both Braille character and graphic information can be fabricated. The power consumptions is very low. The new Braille cell is made based on the electroactive polymer technology. Therefore, the fabrication process will be highly integrated. The cost for making Braille cell will be lowered dramatically. The new Braille cell is so compact it will be used in a variety places.

### BRIEF DESCRIPTION OF THE DRAWINGS

FIG. 1(a), (b), (c). The schematic of the steps to construct a SSH Braille cell and it's working configurations.

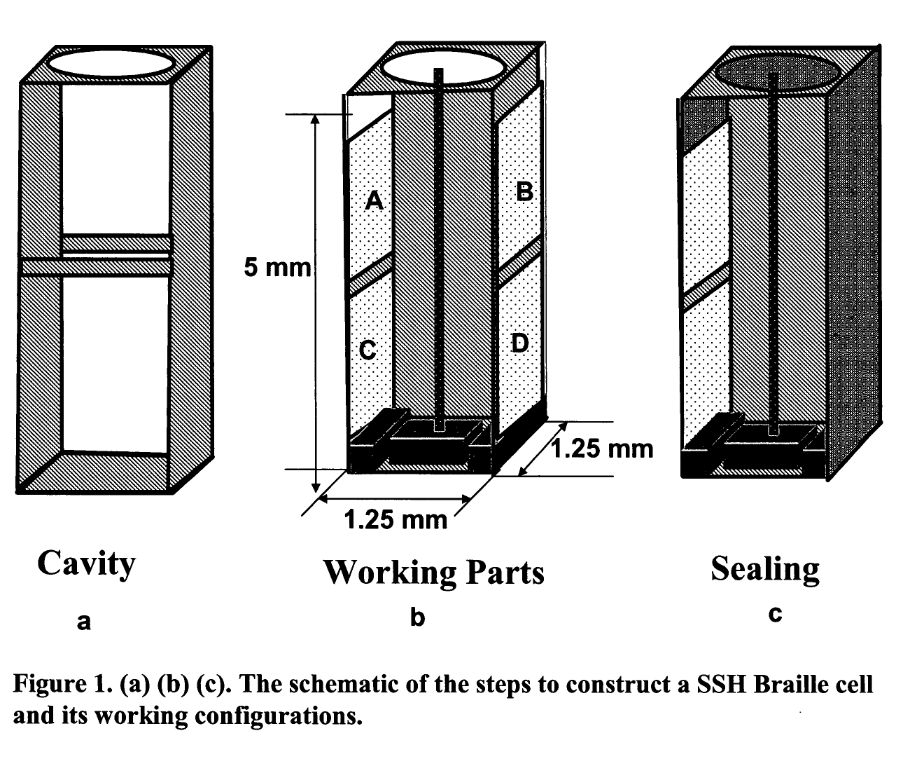

FIG. 2. The working sequence of the hydraulic and latching system in Braille cell.

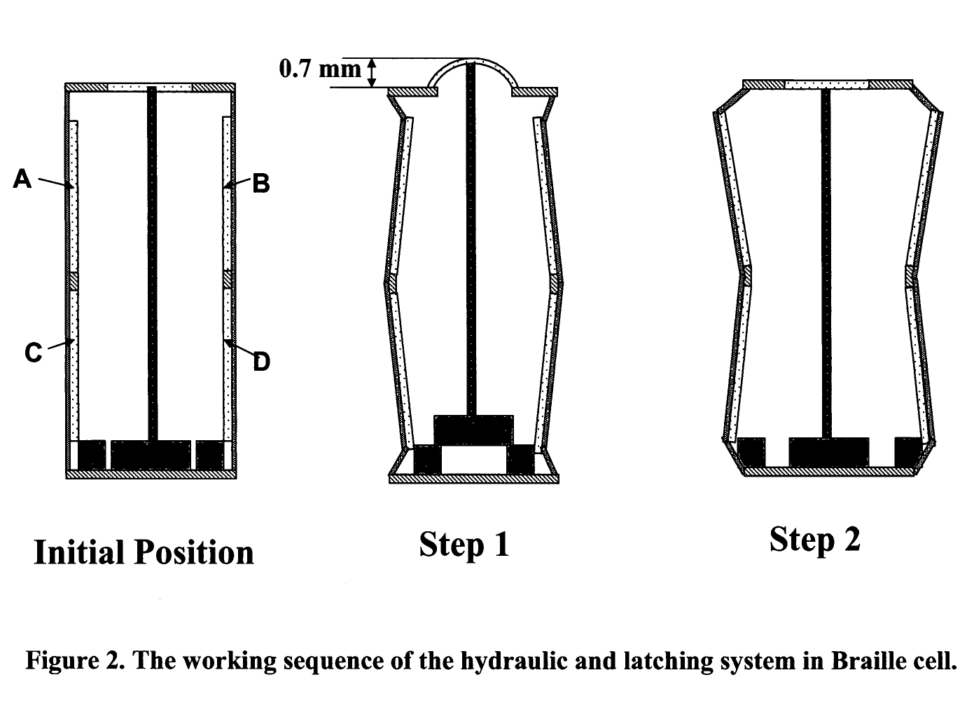

FIG. 3. An array of micro electrodes made on the PVDF polymer thin film.

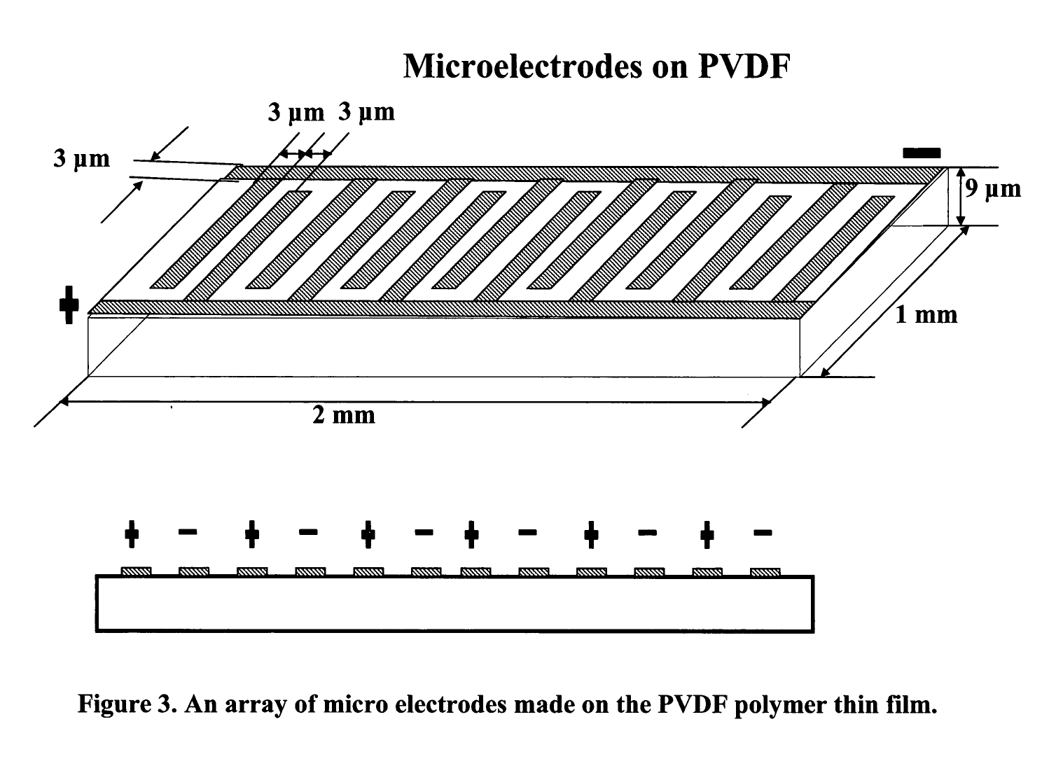

FIG. 4. An single row of cavities

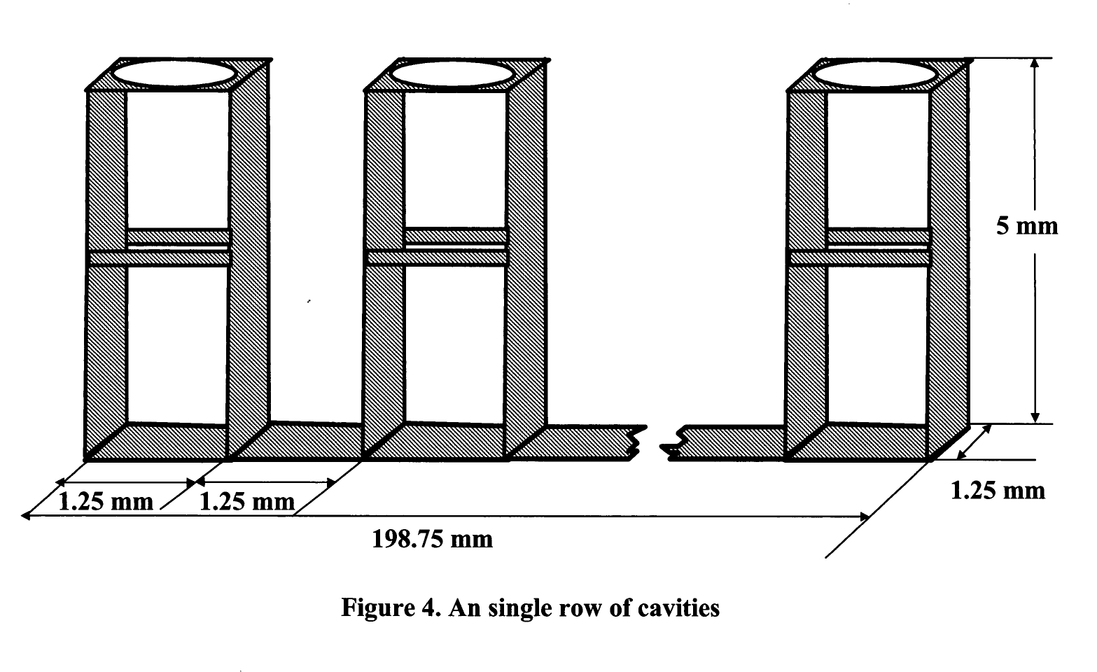

FIG. 5. An single row of cavities with bending elements working at two sides

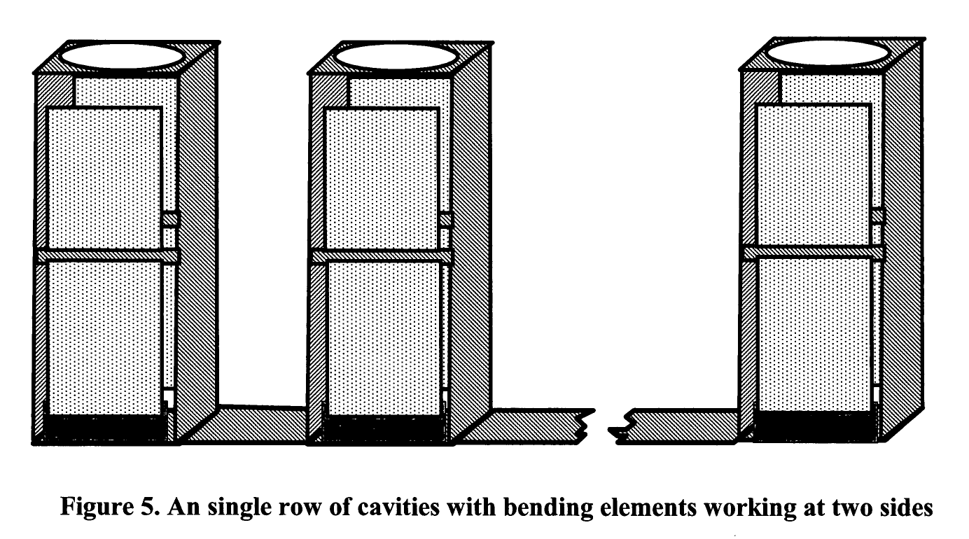

FIG. 6. An single row of cavities with membranes and supporting rod sealing at top.

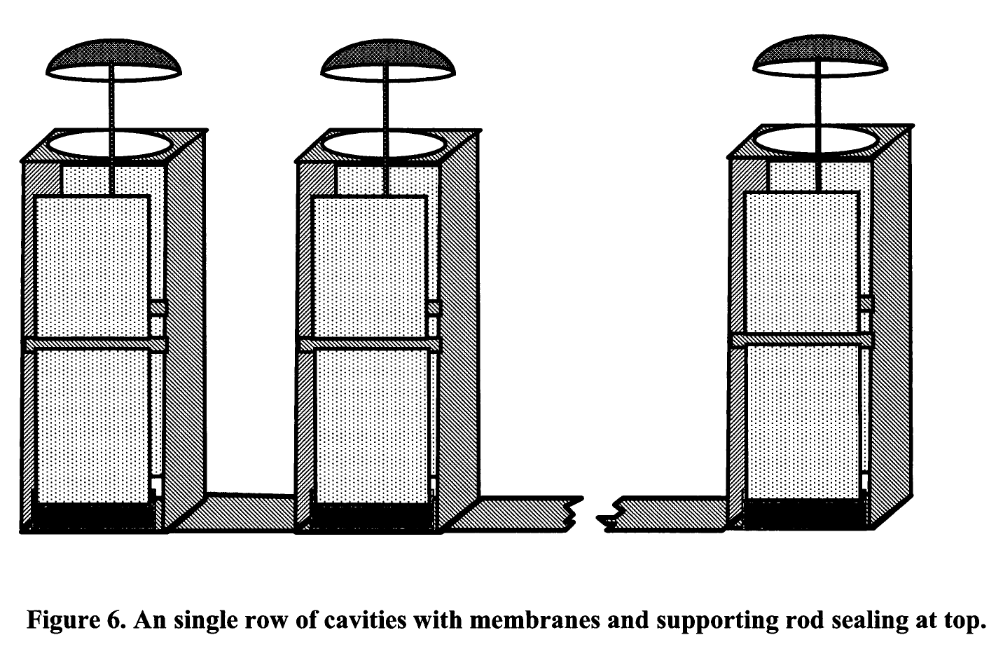

FIG. 7. A multi-line or full page Braille display made by adding single row of working units into an array of Braille dots.

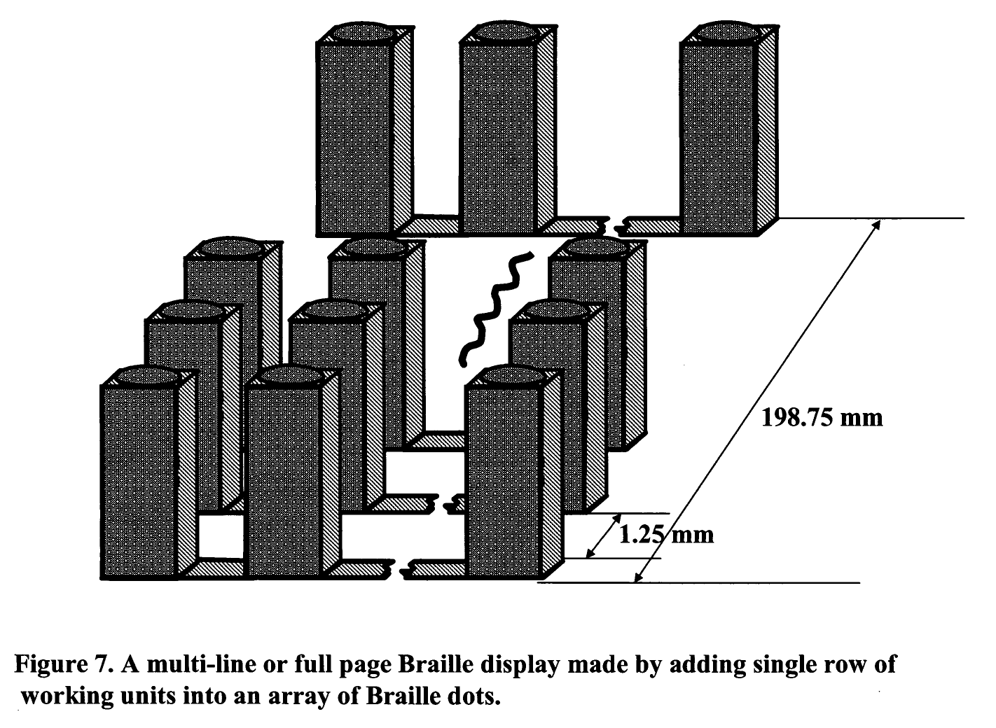

I claim:

1. A Braille cell comprises a cavity with 4 bending elements working at its two sides. The top of the cavity is sealed with the rubber membrane or preformed membrane on which a Braille dot sit. There is a thin rod attached to the back side of the membrane in the cavity. The two supporting blocks are attached to the lower part of the two bending elements which are fixed at the lower part of two sides of the cavity. The cavity is full of the water or other liquid. The bending elements are made of the electroactive polymer including PVDF polymer, IPMC or other electroactive polymer actuators. The four bending elements are fixed at the two rigid stripes at the middle of the two opposite sides of the cavity. Driven by voltage or current the bending elements can bend towards inside or outside of the cavity. The hydraulic and latching mechanism is invented to make the compact and low power consumption Braille cell.

2. A Braille cell as claimed in claim 1 comprises a rectangular cavity with the bending elements working at its two sides.

3. A Braille cell as claimed in claim 1 comprises the cavity with its top sealed with a rubber membrane or preformed membrane.

4. A Braille cell as claimed in claim 1 comprises a thin rod attaching to the back side of the membrane in the cavity. The thin rod can move up and down with the motion of the membrane between reading and rest position.

5. A Braille cell as claimed in claim 1 comprises a cavity which is full of water or other liquid to serve as the pressure transferring medium.

6. A Braille cell as claimed in claim 1 comprises four bending elements fixed at two rigid stripes at the middle of its two opposite sides of the cavity.

7. A Braille cell as claimed in claim 1 comprises two supporting blocks attaching to the lower part of the two bending elements.

8. A Braille cell as claimed in claim 1 comprises the two supporting blocks which move towards the center beneath the thin rod to provide large supporting force at the reading position.

9. The bending elements are actuator made of electroactive polymer such as PVDF polymer, IPMC or other electroactive polymers.

10. The bending elements as claimed in claim 9 comprises the bimorph type actuator made of PVDF polymer which provides cantilever force.

11. The bending elements as claimed in claim 9 comprises using the photolithograph technology to make array of positive and negative electrodes on the surface of the PVDF polymer. The distance between the electrodes is in a range of several micro meters. So the driving voltage can be lowered to under 200 V.

12. The bending elements as claimed in claim 9 comprise IPMC (Ionic Conducting Polymer Metal Composite) to provide cantilever force.

13. The standard integrated microelectronic processing technology will be used to make array of the Braille cells.

14. A microelectronic processing technology as claimed in claim 13 comprises a step that a row of the cavities are made to serve as the housings of the Braille cell.

15. A microelectronic processing technology as claimed in claim 13 comprises a step that a row of the bending elements will be made.

16. A microelectronic processing technology as claimed in claim 13 comprises a step that two rows of the bending elements are put at two sides of the cavities.

17. A integrated microelectronic processing technology as claimed in claim 13 comprises a step that a row of membranes with the thin rod attached to it are put at the top of the cavity to seal the cavities.

18. An integrated microelectronic processing technology as claimed in claim 13 comprises a step that water is filled into the cavities.

19. An integrated microelectronic processing technology as claimed in claim 13 comprises a step that multi line and full page Braille display will be made by adding the rows of the Braille cells together.
